(19) United States
(12) Patent Application Publication
(10) Pub. No.: US 2015/0311598 A1
(43) Pub. Date: Oct. 29, 2015

(54) EXPANDING AXIAL RATIO BANDWIDTH FOR VERY LOW ELEVATIONS

(71) Applicants: Nan WANG, Shanghai (CN); Orville NYHUS, Glendale, AZ (US)

(72) Inventors: Nan Wang, Shang Hai (CN); Orville Nyhus, Glendale, AZ (US)

(21) Appl. No.: 13/978,150

(22) PCT Filed: Mar. 1, 2013
(86) PCT No.: PCT/CN2013/072065

§ 371 Date: Jul. 1, 2015

(51) Int. Cl. H01Q 21/24; G01S 19/33; G01S 19/13

(52) U.S. Cl. CPC H01Q 21/24; G01S 19/13; G01S 19/33

(57) ABSTRACT

Systems and methods for expanding the axial ratio bandwidth at very low elevations are provided. In certain implementations, a system comprises an antenna having a first group of antenna elements and a second group of antenna elements, wherein elements in the first group of antenna elements are reflectively symmetrical about a plane with corresponding elements in the second group of antenna elements; and a global navigation satellite system receiver configured to drive the antenna and process received signals from global navigation satellite system satellites, wherein the global navigation satellite system receiver operates elements in the first group of antenna elements with a first phase delay and the second group of antenna elements with a second, different phase delay and drives the first group of antenna elements and the second group of antenna elements at different power levels.

### BACKGROUND

Circularly-polarized antennas are used extensively in global navigation satellite systems (GNSS), satellite, and radar fields. Further, a ground station that receives signals from GNSS satellites communicates with satellites that are located within the view of the ground station. The satellites in view of the ground station include any satellites located between the zenith, directly above the ground station, and the horizons of the ground station. To receive circularly-polarized signals, the antennas provide a sufficient axial ratio (AR) to receive the signals. However, in certain implementations, the antennas fail to provide a good axial ratio over a sufficient bandwidth. For example, an antenna may fail to provide the appropriate axial ratio for the reception of circularly polarized signals over a wide bandwidth at very low elevation angles where the source of a signal is near the horizon in relation to the location of the antenna.

### SUMMARY

Systems and methods for expanding the axial ratio bandwidth at very low elevations are provided. In certain implementations, a system comprises an antenna haying a first group of antenna elements and a second group of antenna elements, wherein elements in the first group of antenna elements are reflectively symmetrical about a plane with corresponding elements in the second group of antenna elements; and a global navigation satellite system receiver configured to drive the antenna and process received signals from global navigation satellite system satellites, wherein the global navigation satellite system receiver operates elements in the first group of antenna elements with a first phase delay and the second group of antenna elements with a second, different phase delay and drives the first group of antenna elements and the second group of antenna elements at different power levels.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a diagram illustrating an antenna system in one embodiment described in the present disclosure;

FIGS. 2-6 are graphs illustrating the axial ratio for an antenna at different angles away from the zenith for the antenna in one embodiment described in the present disclosure;

FIG. 7 is a diagram illustrating a global navigation satellite system receiver and antenna in one embodiment described in the present disclosure; and

FIG. 8 is a flow diagram for a method for expanding axial ratio bandwidth at low elevations in one embodiment described in the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments of the present disclosure are able to cover a wide bandwidth while providing sufficient axial ratio performance at low elevations. In at least one embodiment, a system includes an antenna that has multiple antenna elements, where the multiple antenna elements are separated into an upper group, positioned above a horizontal plane, and a lower group. Where the lower group is symmetrically positioned below the horizontal plane with respect to the antenna elements in the upper group. Each antenna element in the system has an accompanying phase delay for the transmission and reception of elliptically polarized signals by the antenna elements in the upper group and by the antenna elements in the lower group. To expand the axial ratio performance at low elevations for the communication of signals near the horizon with respect to the antenna location, the phase associated with the lower group is delayed in relation to the phase associated with the upper group. Alternatively, the system expands the axial ratio by receiving and transmitting signals through the elements in the lower group at a different power level in comparison to the elements in the upper group. Further, the system can expand the axial ratio by simultaneously delaying the phase associated with the lower group and driving the elements in the lower group at a different power level in relation to the elements in the upper group. By operating the lower group differently than the upper group, the system is able to receive signals at very low elevations near the horizon associated with the antenna location while having a large axial ratio bandwidth.

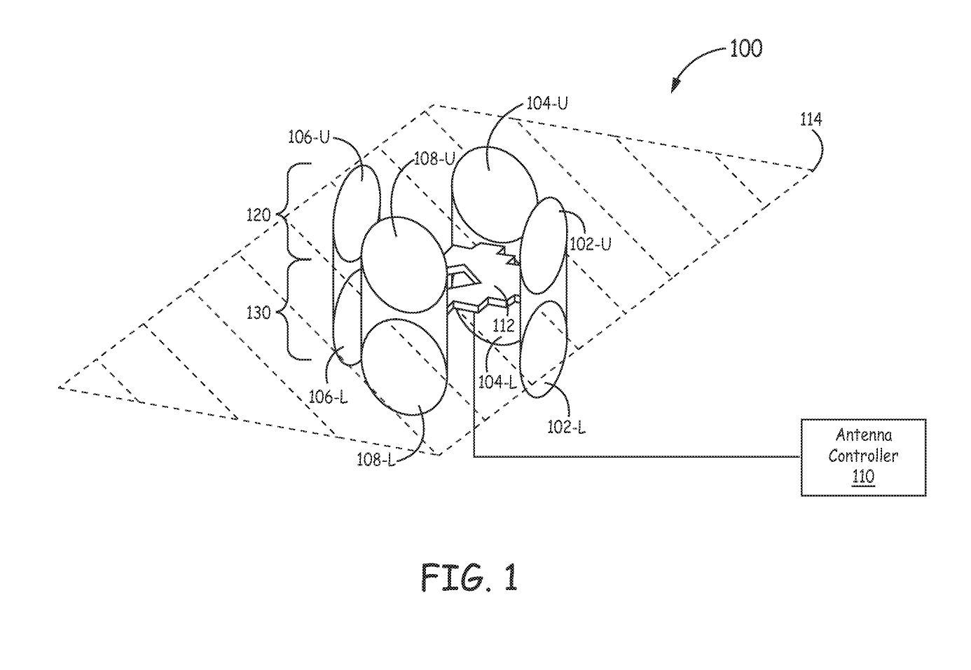

FIG. 1 is a diagram of an antenna 100 that can be driven to improve the axial ratio performance and bandwidth of a system at low elevations. In certain embodiments, the antenna 100 includes multiple elements joined together by a joining member 112 where the joining member 112 routes electrical connections between the antenna elements and an antenna controller 110. In at least one implementation, the joining member 112 lies in an exemplary plane 114 that separates the elements into two different groups. For example, when there are eight elements as shown, the exemplary plane 114 separates the elements into an upper group 120 that includes elements 102-U, 104-U, 106-U, and 108-U; and a lower group 130 that includes elements 102-L, 104-L, 106-L, and 108-L. In certain applications, where the antenna 100 facilitates the reception and transmission of signals as part of a ground based system, the elements 102-h, 104-h, 1064,, and 1084, in the lower group 130 are located closer to the ground than the corresponding elements 102-U, 104-U, 106-U, and 108-U in the upper group 120. In an alternative implementation, the joining member 112 connects to different locations of the antenna elements, where the antenna elements are still divided into an upper group 120 and a lower group 130, where the location of the joining member 112 is not aligned with the horizontal plane 114. In at least one implementation, the elements of the antenna 100 are round monopole antenna elements. For example, each monopole element has a half-perimeter that is equal to one quarter of the wavelength of the center operating frequency for a particular antenna element.

In certain embodiments, each element in the upper group 120 is associated with a corresponding element in the lower group 130 such that each element in the upper group 120 is symmetrically arranged with respect to a corresponding element in the lower group 130. For example, the elements 102-U and 102-L have a mirror symmetry with respect to one another about the exemplary plane 114. Likewise, elements 104-U and 104-L; 106-U and 106-L; and 108-U and 108-L also have a mirror symmetry with respect to one another about the exemplary plane 114. In at least one implementation, each set of corresponding elements in the upper group 120 and the lower group 130 are the same distance away from one another. Further, an antenna. controller 110 is able to delay each element of the antenna 100 separately such that the antenna 100 is able to respond to electromagnetic waves having different polarizations. For example, when the antenna is configured to receive and transmit right hand circular polarized signals, an antenna controller 110 is able to delay signals received over or transmitted through antenna element 104-U by a phase delay of 90°, signals received over or transmitted through antenna element 106-U by a phase delay of 180°, and signals received over or transmitted through antenna element 108-U by a phase delay of 270°, while signals received over or transmitted through antenna element 102-U are not delayed. Likewise, the elements in the lower group 130 are similarly delayed. When received or transmitted signals are delayed as described above, the antenna 100 is configured to emit or receive right hand circular polarized signals. Similarly, the antenna controller 110 is able to delay signals received over or transmitted through antenna element 108-U by a phase delay of 90°, signals received over or transmitted through antenna element 106-U by a phase delay of 180°, and signals received over or transmitted through antenna element 104-U by a phase delay of 270°, while signals received over or transmitted through antenna element 102-U are not delayed, where again the elements in the lower group 130 are similarly delayed. When received or transmitted signals are delayed as described immediately above, the antenna 100 is configured to emit or receive right hand circular polarized signals. Other various elliptical polarizations, (such as, for example, left hand circular polarized signals) can also be emitted through the antenna 100 by controlling the phase delay of the elements in the upper group 120 and the lower group 130.

In certain embodiments, the arrangement of elements of the antenna 100, allow the antenna to have an improved axial ratio bandwidth. The phrase “axial ratio,” as used herein, refers to the ratio of the magnitudes of the major and minor axis defined by the electric field factor as is understood by one having skill in the art. For example, when a signal received through antenna 100 is circularly and elliptically polarized, the axial ratio of the antenna is one, as both the major and minor axes of the electric field are equal. In contrast, when a signal is linearly polarized, the axial ratio of the antenna is infinite because the magnitude of the minor axis is zero. When the axial ratio is between 1 and infinity, the signal is elliptically polarized but not circularly polarized. Further, the phrase “axial ratio bandwidth,” as used herein, refers to the frequency range through which an antenna maintains its polarization and, when an antenna emits or receives circularly polarized signals, this number expresses the quality of the circular polarization of an antenna. Further, through mechanical positioning of the antenna receiver, the antenna is also capable of receiving or emitting elliptical (but not circular) or linearly polarized signals. In certain applications, circular polarized signals are used extensively. For example, an antenna that receives signals from global navigation satellite system (GNSS) satellites generally has a sufficient axial ratio bandwidth to facilitate the reception of circular polarized signals emitted from a particular satellite. As satellites can be found at any location above the horizon with respect, to the antenna location, the performance of a GNSS receiver is improved when the receiving antenna is able to receive signals from any location above the horizon while still maintaining a sufficient axial ratio. For instance, the performance of a GNSS receiver is improved when the antenna has a low axial ratio at every location from the zenith (straight above the antenna) to very low elevation angles near the horizon.

In certain embodiments, to improve the axial ratio bandwidth for antenna 100 at every location above the horizon of the antenna 100, the elements in the upper group 120 of antenna elements, which includes elements 102-U, 104-U, 106-U, and 108-U, are delayed differently than the antenna elements in the lower group 130 of antenna elements, which includes elements 102-L, 104-L, 106-L, and 108-L. For example, the elements in the lower group 130 of antenna elements may have a phase delay that is offset by 60° in relation to the corresponding antenna element in the upper group 120 of antenna elements. In a particular example of a phase delay offset of 60° for the lower group 130, antenna element 104-U in the upper group of antenna elements may be delayed by 90° and the corresponding antenna element 104-L in the lower group of antenna elements may be delayed by 150°. Similarly, when the antenna element 106-U is delayed by 180° as described above for the emission and reception of circularly polarized signals, the corresponding antenna element 106-L may be delayed by 230°, which has a delay that is offset from the corresponding antenna element 106-U in the upper antenna group 120. Alternatively, the lower group 130 can be delayed by a phase delay of any magnitude in relation to the upper group 120. When the lower group 130 is delayed in relation to the upper group 120, the lower group 130 will be configured to receive or transmit circularly polarized signals that are phase delayed in comparison to corresponding elements in the upper group 120. In at least one implementation, the antenna controller 110 determines the phase delay offset between the upper group 120 and the lower group 130 based upon the frequency of signals that are received or transmitted through the antenna 100.

Alternatively, the axial ratio bandwidth for an antenna. 100 can be improved by driving corresponding antenna elements at different power levels. To drive corresponding antenna elements at different power levels, an antenna controller 110 can drive the antenna elements 102-U, 104-U, 106-U, and 108-U in the upper group 120 of antenna elements by a power level that is greater than the power level of the antenna elements 102-L, 104-L, 106-L, and 108-L in the lower group 130. For example, an antenna controller 110 drives the antenna elements 102-L, 104-L, 106-L, and 108-L at a power level that is one tenth of the power level at which the antenna controller 110 drives the antenna elements 102-U, 104-U, 106-U, and 108-U in the upper group of antenna elements. In at least one implementation, the antenna controller 110 determines the difference in power level between the upper group 120 and the lower group 130 based upon the frequency of signals that are received or transmitted through the antenna 100. By performing combinations of driving the antenna elements at different power levels and phase delaying corresponding antenna elements, the axial ratio bandwidth for the antenna 100 can be improved at very low elevations near the horizon.

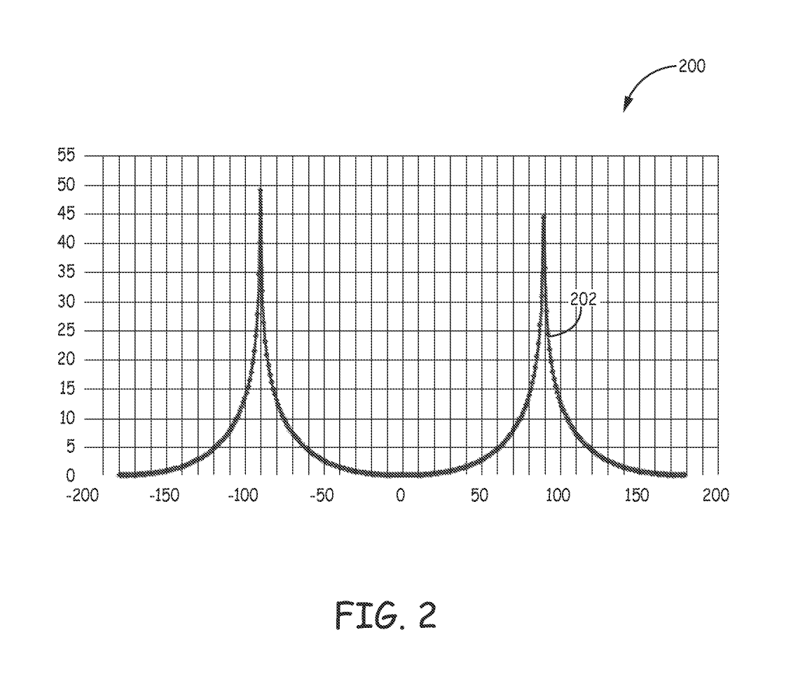

FIGS. 2-6 are graphs that illustrate the axial ratio at various angles in relation to the zenith for an antenna that operates, in some implementations, as described above in relation to FIG. 1. For example, FIG. 2 illustrates a graph 200 of the axial ratio result 202 for an antenna (such as antenna 100 in FIG. 1) when both the elements in the upper group 120 and the elements in the lower group 130 are driven with the same respective phase delay and the same power. As illustrated, the axial ratio result 202 for the particular antenna increases sharply as the angle away from the zenith approaches angles of 90°, where the angle of 90° corresponds to the horizon associated with a particular antenna location. Thus, when the antenna is driven such that the upper group 120 and the lower group 130 have the same respective phase delay and the same power, the antenna may have difficulty accurately receiving signals from sources that are very close to the horizon of the antenna or located at angles near 90° from the zenith of the antenna.

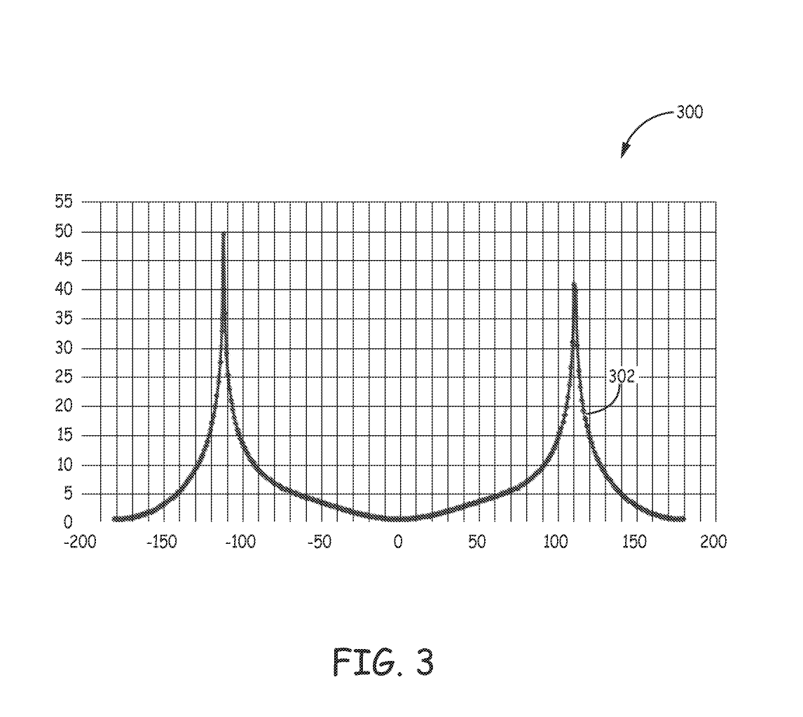

FIG. 3 illustrates a graph 300 of the axial ratio result 302 for an antenna (such as antenna 100 in FIG. 1) Where the lower group 130 is driven at a phase delay of 60° with respect to the corresponding elements in the upper group 120. As shown, in FIG. 3, the axial ratio result 302 illustrates an improved performance when compared to the axial ratio when both the upper group 120 and the lower group 130 are driven the same with respect to phase delay and power as shown in FIG. 2. For example, the maximum axial ratio in axial ratio result 302 is shifted from being located at 90° in FIGS. 2 to 110° because of the delay offset of the lower group 130 in relation to the upper group 120. The shift in axial ratio improves the antenna's ability to receive signals at or near the horizon of the antenna. However, the axial ratio performance still decreases slightly at 90° when referenced against the axial ratio associated with the zenith of the antenna.

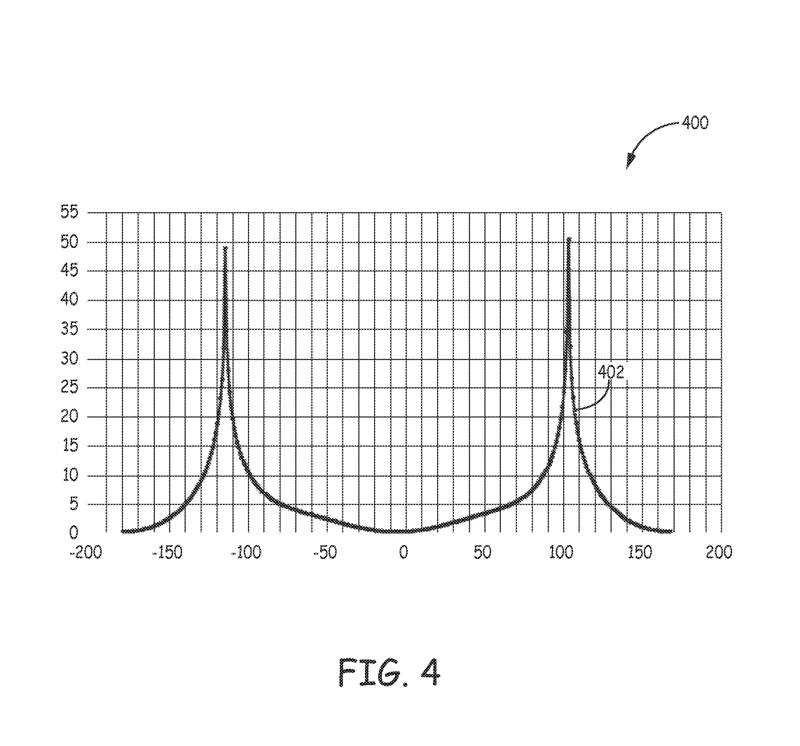

With a similar appearance to FIG. 3, FIG. 4 illustrates a graph 400 of the axial ratio result 402 for an antenna where the lower group 130 is driven at one tenth the power level of the upper group 120. As shown in FIG. 4, the maximum axial ratio in axial ratio result 402 is located at a similar angle in relation to the location of the antenna 100 as axial ratio result 302 in FIG. 3. Thus, driving the lower group 130 at a tenth the power of the upper group 120 has similar performance at 90° from the zenith of the antenna as the antenna performance described by axial ratio result 302 in FIG. 3.

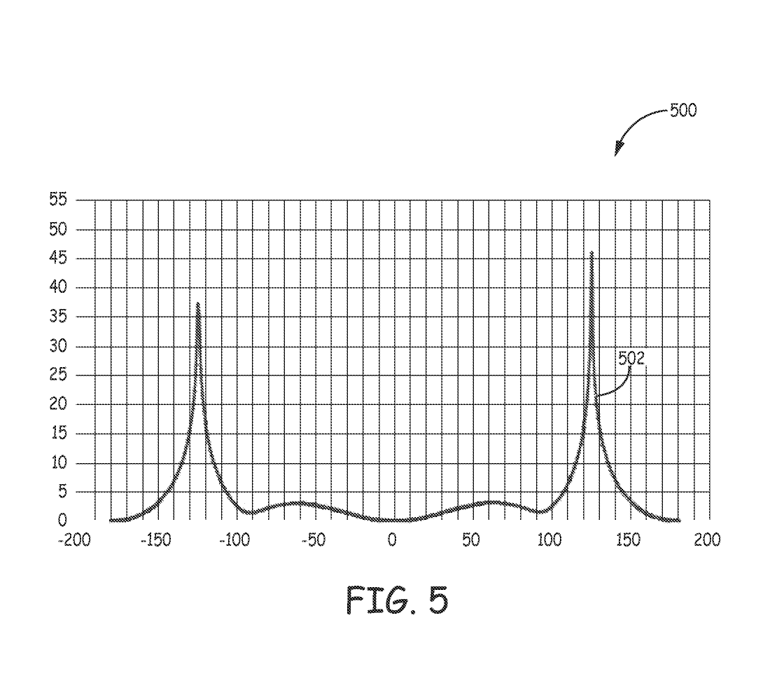

FIG. 5 illustrates a graph 500 of the axial ratio result 502 for an antenna where the lower group 130 is driven at a phase delay of 60° with respect to the corresponding elements in the upper group 120 and the lower group 130 is driven at one tenth the power level of the upper group 120. As shown in FIG. 5, the axial ratio result 502 illustrates an improved performance when compared to the axial ratio when both the upper group 120 and the lower group 130 are driven the same with respect to phase delay and power. Further, the axial ratio result 502 illustrates an improved performance when compared to the axial ratio when the lower group 130 has a phase delay when compared to the upper group 120 or when the lower group 130 is driven at a different power level when compared to the upper group 120. For example, when the lower group 130 is both phase delayed and driven at a different power level, the maximum axial ratio in axial ratio result 502 shifts from being located at 90°, as shown in FIG. 2, to being located at about 125° from the zenith of the antenna. As illustrated in graph 500, the axial ratio at 90° is also significantly improved. Thus, when the lower group 130 is both driven at a different power level or phase delayed in relation to the upper group 120, an antenna is able to receive circularly polarized signals from sources located at or near the horizon more successfully.

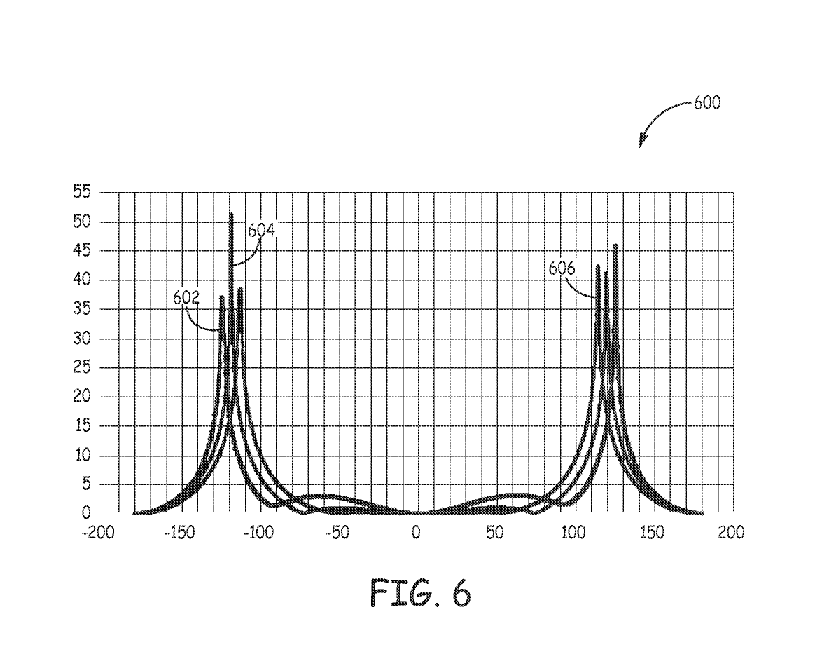

FIG. 6 illustrates a graph 600 that illustrates the axial ratio results 602, 604, and 606 provided by an antenna that functions similarly to antenna 100 in FIG. 1. Further axial ratio results 602 and 606 represent antennas that are driven as described above in relation to axial ratio result 502 in FIG. 5. Further, the axial ratio results 602 and 606 illustrate the axial ratio in response to signals transmitted from GNSS satellites in different frequency bands. For example, axial ratio result 602 represents the axial ratio for the reception of signals transmitted from a GNSS satellite at 1.575 GHz. Axial ratio result 606 represents the axial ratio for the reception of signals transmitted from a GNSS satellite at 1.2 GHz. In contrast, axial ratio result 604 represents the axial ratio for the reception of signals transmitted from a GNSS satellite at 1.2 GHz, when the elements in the lower group 130 are phase delayed by 90° with respect to corresponding elements in the upper group 120 and the elements in the lower group 130 are driven at one tenth the power of elements in the upper group 120. In certain implementations, the antenna controller 110 is able to drive the elements of both the upper group 120 and the lower group 130 over multiple frequency bands simultaneously.

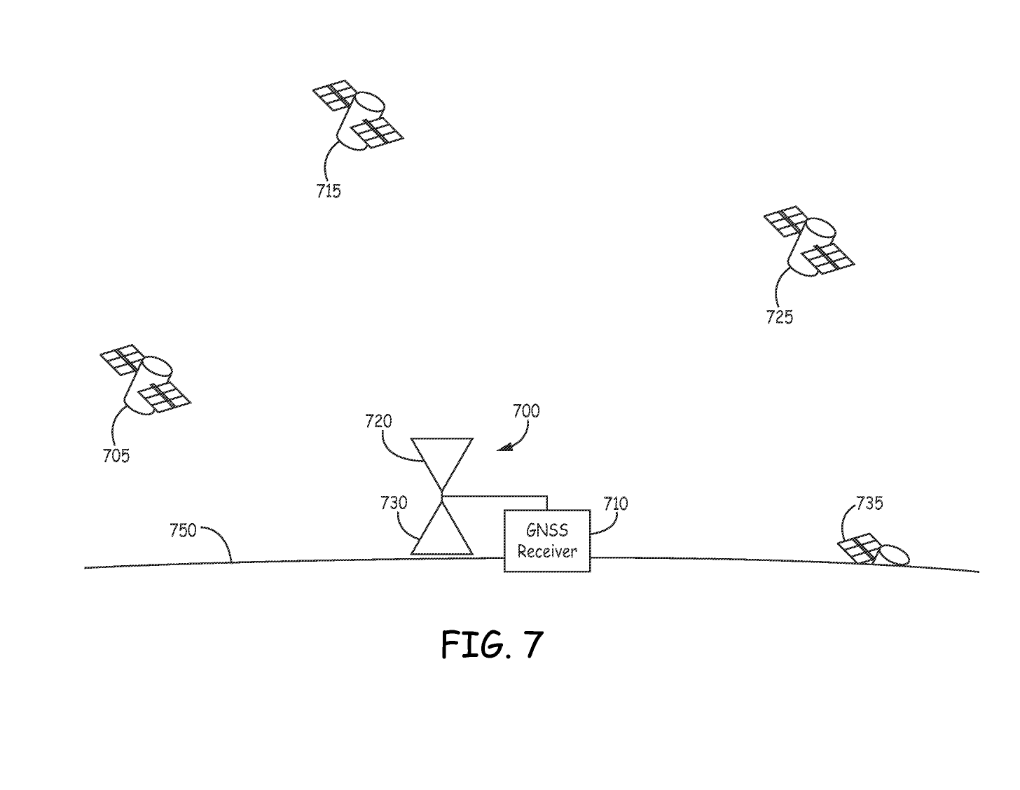

FIG. 7 illustrates a block diagram of a GNSS system for receiving signals satellites. The GNSS system includes a GNSS receiver 702 that functions as an antenna controller for antenna 700. Antenna 700 is capable of receiving circularly polarized signals from visible satellites, where the antenna 700 includes an upper group 720 of antenna elements and a lower group 730 of antenna elements. For example, the satellites 705, 715, 725, and 735 are located at different locations in the sky that are visible to antenna 700. When both the upper group 720 and the lower group 730 are identically driven by the GNSS receiver 710, the antenna is able to maintain a sufficient axial ratio when receiving signals from satellites 705, 715, and 725. However, antenna 735 is near the horizon 750 in relation to the location of the antenna 700 and the axial ratio is high, such that the antenna 700 has difficulty receiving circularly polarized signals from the antenna 735.

To facilitate the reception of signals from satellites located near the horizon 750, the GNSS receiver drives the lower group 730 of antenna elements differently than the upper group 720 of antenna elements. For example, the GNSS receiver delays the phase of signals received through the lower group 730 in relation to signals received through the upper group 720. Alternatively, the GNSS receiver drives the lower group 730 at a different power level than the upper group 720. Further, the GNSS receiver delays signals received through the different groups of elements and drives the different groups of elements according to the frequency of the received signals. For example, the GNSS receiver changes the delays and power of the antenna. groups if the signals are being received in the L1, L2, or L3 bands. Further, the GNSS receiver 710 can drive the antenna elements to receive signals in multiple bands simultaneously. When the GNSS receiver 710 delays and/or drives the lower group 730 differently than the upper group 720, the GNSS receiver 710 can alter the axial ratio of the antenna 700 such that the antenna 700 can efficiently receive circular polarized signals from satellites that are located near the horizon 750.

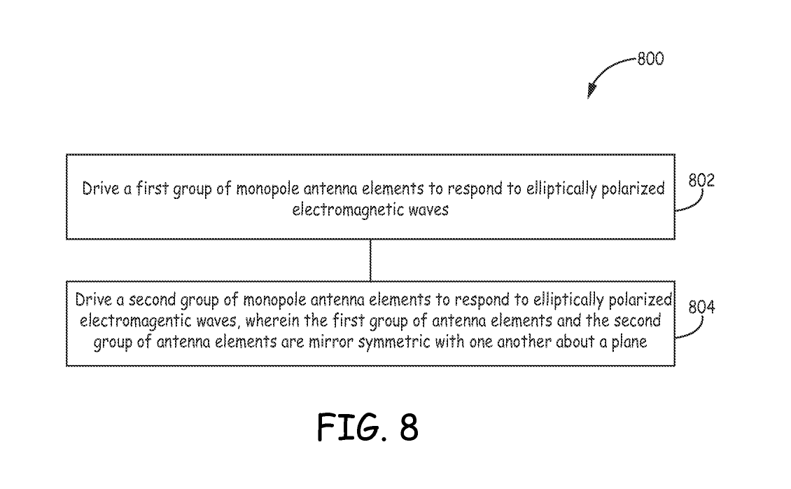

FIG. 8 is a flow diagram of a method 800 for driving an antenna to expand axial ratio bandwidth at low elevations. Method 800 proceeds at 802 where a first group of monopole antenna elements is driven to respond to elliptically polarized electromagnetic waves. Method 800 proceeds to 804 where a second group of monopole antenna elements is driven to respond to elliptically polarized electromagnetic waves, wherein the first group of antenna elements and the second group of antenna elements are mirror symmetric with one another about a plane. In certain implementations, the driving of the monopole antenna elements extends the axial ratio bandwidth when the first group of antenna elements and the second group of antenna elements are driven differently from one another. For example, an antenna controller drives the first group at a different phase delay in relation to the second group. Alternatively, the antenna controller drives the first group and the second group at different power levels.

### EXAMPLE EMBODIMENTS

Example 1 includes an antenna system, the antenna system comprising: an antenna having a first group of antenna elements and a second group of antenna elements, wherein the first group and the second group are symmetrical arranged about a plane; and an antenna controller configured to drive the first group of antenna elements differently than the second group of antenna elements, wherein the antenna controller drives the first group of antenna elements and the second group of antenna elements to respond to elliptically polarized electromagnetic waves.

Example 2 includes the antenna system of Example 1, wherein the antenna controller operates elements in the first group of antenna elements with a first phase delay and the second group of antenna elements with a second, different phase delay.

Example 3 includes the antenna system of any of Examples 1-2, wherein the antenna controller drives the first group of antenna elements and the second group of antenna elements at different power levels.

Example 4 includes the antenna system of any of Examples 1-3, wherein the antenna controller provides a first phase delay for the first group of antenna elements that is different than a second phase delay for the second group of antenna elements and drives the first group of antenna elements and the second group of antenna elements at different power levels.

Example 5 includes the antenna system of Example 4, wherein the antenna controller determines the difference between the first phase delay and the second phase delay and determines the different power levels based on the frequency of signals received or transmitted through the antenna.

Example 4 includes the antenna system of any of Examples 1-5, wherein the antenna controller provides multiple signals to elements in the first group of antenna elements that are delayed at a plurality of different phase delays, wherein the plurality of different phase delays are different than phase delays for corresponding elements in the second group of antenna elements.

Example 7 includes the antenna system of any of Examples 1-6, wherein each of the first group of antenna elements and the second group of antenna elements comprise four round monopole radiators that are joined together such that the four round monopole radiators in a group of antenna elements are located at vertices of a square-like joining member.

Example 8 includes the antenna system of any of Examples 1-7, wherein the antenna receives signals from at least one global navigation satellite system satellite.

Example 9 includes the antenna system of any of Examples 1-8, wherein the antenna receives signals in at least one global navigation satellite system frequency band.

Example 10 includes a method for extending axial ratio bandwidth at low elevations for an antenna, the method comprising: driving a first group of monopole antenna elements to respond to elliptically polarized electromagnetic waves; and driving a second group of monopole antenna elements to respond to elliptically polarized electromagnetic waves, wherein the first group of antenna elements and the second group of antenna elements are mirror symmetric with one another about a plane.

Example 11 includes the method of Example 10, wherein elements in the first group of monopole antenna elements are driven with an associated phase delay that is different than the phase delay that drives corresponding elements in the second group of monopole antenna. elements.

Example 12 includes the method of any of Examples 10-11, wherein the first group of monopole antenna elements and the second group of monopole antenna elements are driven at different power levels.

Example 13 includes the method of any of Examples 10-12, wherein elements in the first group of monopole antenna elements have an associated phase delay in relation to corresponding elements in the second group of monopole antenna elements and the first group of monopole antenna elements and the second group of monopole antenna elements are driven at different power levels.

Example 14 includes the method of Example 13, wherein the associated phase delay and the different power levels are determined based on the frequency of signals received or transmitted through the antenna.

Example 15 includes the method of any of Examples 10-14, wherein an antenna element in the first group of monopole antenna elements is associated with a plurality of different phase delays, wherein the plurality of different phase delays are different than the phase delays for corresponding elements in the second group of monopole antenna elements.

Example 16 includes the method of any of Examples 10-15, further comprising receiving signals from at least one global navigation satellite system satellite.

Example 17 includes a system for receiving signals from GNSS satellites, the system comprising: an antenna having a first group of antenna elements and a second group of antenna elements, wherein elements in the first group of antenna elements are reflectively symmetrical about a plane with corresponding elements in the second group of antenna elements; and a global navigation satellite system receiver configured to drive the antenna and process received signals from global navigation satellite system satellites, wherein the global navigation satellite system receiver operates elements in the first group of antenna elements with a first phase delay and the second group of antenna elements with a second, different phase delay and drives the first group of antenna elements and the second group of antenna elements at different power levels.

Example 18 includes the system of any of Examples 17, wherein the global navigation satellite system receiver determines the difference between the first phase delay and the second phase delay and determines the different power levels based on the frequency of signals received or transmitted through the antenna.

Example 19 includes the system of any of Examples 17-18, wherein the global navigation satellite system receiver provides multiple signals to elements in the first group of antenna elements that are delayed at a plurality of different phase delays, wherein the plurality of different phase delays are different than phase delays for corresponding elements in the second group of antenna elements.

Example 20 includes the system of any of Examples 17-19, wherein each of the first group of antenna elements and the second group of antenna elements comprise four round monopole radiators that are joined together such that the four round monopole radiators in a group of antenna elements are located at vertices of a square-like joining member.

Although specific embodiments have been illustrated and described herein, it will be Appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. an antenna system, the antenna system comprising:
an Antenna having a first group of antenna elements and a second group of antenna elements, wherein the first group and the second group are symmetrical arranged about a plane; and
an antenna controller configured to drive the first group of antenna elements differently than the second group of antenna elements, wherein the antenna controller drives the first group of antenna elements and the second group of antenna elements to respond to elliptically polarized electromagnetic waves.

2. The antenna system of claim 1, wherein the antenna controller operates elements in the first group of antenna elements with a first phase delay and the second group of antenna elements with a second, different phase delay.

3. The antenna system of claim 1, wherein the antenna controller drives the first group of antenna elements and the second group of antenna elements at different power levels.

4. The antenna system of claim 1, wherein the antenna controller provides a first phase delay for the first group of antenna elements that is different than a second phase delay for the second group of antenna elements and drives the first group of antenna elements and the second group of antenna elements at different power levels.

5. The antenna system of claim 4, wherein the antenna controller determines the difference between the first phase delay and the second phase delay and determines the different power levels based on the frequency of signals received or transmitted through the antenna.

6. The antenna system of claim 1, wherein the antenna controller provides multiple signals to elements in the first group of antenna elements that are delayed at a plurality of different phase delays, wherein the plurality of different phase delays are different than phase delays for corresponding elements in the second group of antenna elements.

7. The antenna system of claim 1, wherein each of the first group of antenna elements and the second group of antenna elements comprise four round monopole radiators that are joined together such that the four round monopole radiators in a group of antenna elements are located at vertices of a square-like joining member.

8. The antenna system of claim 1, wherein the antenna receives signals from at least one global navigation satellite system satellite.

9. The antenna system of claim 1, wherein the antenna receives signals in at least one global navigation satellite system frequency band.

10. A method for extending axial ratio bandwidth low elevations for an antenna, the method comprising:
driving a first group of monopole antenna elements to respond to elliptically polarized electromagnetic waves; and
driving a second group of monopole antenna elements to respond to elliptically polarized electromagnetic waves, wherein the first group of antenna elements and the second group of antenna elements are mirror symmetric with one another about a plane.

11. The method of claim 10, wherein elements in the first group of monopole antenna elements are driven with an associated phase delay that is different than the phase delay that drives corresponding elements in the second group of monopole antenna elements.

12. The method of claim 10, wherein the first group of monopole antenna elements and the second group of monopole antenna elements are driven at different power levels.

13. The method of claim 10, wherein elements in the first group of monopole antenna elements have an associated phase delay in relation to corresponding elements in the second group of monopole antenna elements and the first group of monopole antenna elements and the second group of monopole antenna elements are driven at different power levels.

14. The method of claim 13, wherein the associated phase delay and the different power levels are determined based on the frequency of signals received or transmitted through the antenna.

15. The method of claim 10, herein an antenna element in the first group of monopole antenna elements is associated with a plurality of different phase delays, wherein the plurality of different phase delays are different than the phase delays for corresponding elements in the second group of monopole antenna elements.

16. The method of claim 10, further comprising receiving signals from at least one global navigation satellite system satellite.

17. A system for receiving signals from GNSS satellites, the system comprising:
an antenna having a first group of antenna elements and a second group of antenna elements, wherein elements in the first group of antenna elements are reflectively symmetrical about a plane with corresponding elements in the second group of antenna elements; and
a global navigation satellite system receiver configured to drive the antenna and process received signals from global navigation satellite system satellites, wherein the global navigation satellite system receiver operates elements in the first group of antenna elements with a first phase delay and the second group of antenna elements with a second, different phase delay and drives the first group of antenna elements and the second group of antenna elements at different power levels.

18. The system of claim 17, wherein the global navigation satellite system receiver determines the difference between the first phase delay and the second phase delay and determines the different power levels based on the frequency of signals received or transmitted. through the antenna.

19. The system of claim 17, wherein the global navigation satellite system receiver provides multiple signals to elements in the first group of antenna elements that are delayed at a plurality of different phase delays, wherein the plurality of different phase delays are different than phase delays for corresponding elements in the second group of antenna elements.

20. The system of claim 17, wherein each of the first group of antenna elements and the second group of antenna elements comprise four round monopole radiators that are joined together such that the four round monopole radiators in a group of antenna elements are located at vertices of a square-like joining member.
